(19) United States
(12) Patent Application Publication
(10) Pub. No.: US 2025/0181215 A1
(43) Pub. Date: Jun. 5, 2025

(54) PROACTIVE PROMPTING FOR CONTENT ENHANCEMENT VIA FOUNDATION MODEL INTEGRATIONS IN APPLICATIONS

(71) Applicant: Microsoft Technology Licensing, LLC, Redmond, WA (US)

(72) Inventor: Sarah Ragab Ismail SALEH, Vancouver (CA)

(21) Appl. No.: 18/529,663

(22) Filed: Dec. 5, 2023

(51) Int. Cl. G06F 3/0484; G06F 3/0482; G06F 9/451

(52) U.S. Cl. CPC G06F 3/0484; G06F 3/0482; G06F 9/451

(57) ABSTRACT

Technology is disclosed herein for proactive prompting for content generation via a foundation model integration. In an implementation, a computing device displays a content canvas populated with content in a user interface of an application and captures the state of the content canvas. The computing device generates a prompt for a foundation model which tasks the foundation model with generating follow-on prompts for enhancements to the content of the content canvas. The computing device displays suggestion components corresponding to the follow-on prompts in the user interface. In response to a selection of one of the suggestion components, the computing device sends a follow-on prompt corresponding to the selected suggestion component to the foundation model, then populates the content canvas with an enhancement generated by the foundation model in response to the follow-on prompt.

### TECHNICAL FIELD

Aspects of the disclosure are related to the field of software applications and foundation model integrations in application environments.

### BACKGROUND

Productivity applications often include project canvases for freeform ideation and content generation. For example, virtual whiteboard applications facilitate project planning and collaboration by providing a digital canvas for teams to brainstorm, organize, and visualize their ideas in a dynamic and accessible format. These applications often include the ability to host online meetings or work sessions during which collaborators can interact to shape the content of a project in real time. Project canvases allow users to post and share content or ideas in different formats (e.g., text, images, video clips, etc.) where other users can review the content at their convenience, promoting accessibility. And as users share content, provide feedback on ideas, exchange text messages, and so on, the software stores the information to keep a complete and accurate record of the project as it is developed.

However, while productivity applications can facilitate freeform ideation and content generation, in a number of ways the technology suffers from drawbacks unique to the format. For example, the ease with which content can be created and added to a project can lead to an overabundance of data, making it challenging to sift through and locate relevant information, potentially causing confusion, duplicative activity, and wasted effort. As the digital canvas fills up with content, the workspace can become disorganized and lose coherence, leading to less fluid interaction. Moreover, effective communication on virtual whiteboards involves a mix of text, drawings, annotations, and other forms of input. Balancing these elements and ensuring that ideas are not overlooked can be challenging. And despite their potential for facilitating many aspects of project planning, for optimal usage, users must adapt to a new workflow, adding extra steps that can disrupt the creative process.

### Overview

Technology is disclosed herein for proactive prompting for content enhancement via a foundation model integration. In an implementation, a computing device displays a content canvas populated with content in a user interface of an application and captures the state of the content canvas. The computing device generates a prompt for a foundation model which tasks the foundation model with generating follow-on prompts for enhancements the content of the content canvas based on contextual information including the state of the content canvas. The computing device displays suggestion components corresponding to the follow-on prompts in the user interface. In response to a selection of one of the suggestions, the computing device sends a follow-on prompt corresponding to the selected suggestion to the foundation model, then populates the content canvas with the enhancement generated by the foundation model in response to the follow-on prompt. In an implementation, the prompt also tasks the foundation model with generating titles for the follow-on prompts, and the computing device displays the suggestion components labeled with the titles.

In various implementations, the computing device captures the state of the content canvas in response to detecting a change to the state of the content canvas. In an implementation, the computing device captures an updated state of the content canvas in response to a change in the state of the content canvas. The computing device generates another prompt for the foundation model which tasks the foundation model with generating new suggestions based on the updated state of the content canvas.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for proactive prompting for content enhancement via a foundation model integration in an implementation.

FIG. 2 illustrates a process for proactive prompting via a foundation model integration in an implementation.

FIG. 3 illustrates an operational environment for proactive prompting for content enhancement via a foundation model integration in an implementation.

FIG. 4 illustrates an operational scenario for proactive prompting for content enhancement via a foundation model integration in an implementation.

FIGS. 5A-5E illustrate user experiences for proactive prompting for content enhancement via a foundation model integration in an implementation.

FIG. 6 illustrates a workflow for proactive prompting for content enhancement via a foundation model integration in an implementation.

FIGS. 7A and 7B illustrate a prompt template for proactive prompting for content enhancement via a foundation model integration in an implementation.

FIG. 8 illustrates generating an enhancement for a content canvas in an implementation.

FIG. 9 illustrates a computing system suitable for implementing the various operational environments, architectures, processes, scenarios, and sequences discussed below with respect to the other Figures.

### DETAILED DESCRIPTION

Various implementations are disclosed herein for proactively prompting a foundation model for freeform ideation and content generation in the environment of a software application, such as a word processing, presentation, note-taking, virtual whiteboard, or other application. In an implementation, the application prompts a foundation model to provide suggestions for enhancing or improving the content of a content board or canvas. Rather than waiting for a user to request assistance with his or her content, the application automatically and proactively captures information from the canvas and supplies it to the foundation model to generate suggestions. The information captured and sent to the foundation model includes contextual information and canvas metadata. The contextual information captured may include information which a user might overlook or be unable to quantify or describe in a natural language prompt, especially if the canvas has accumulated a significant amount of content. Moreover, as the content of the canvas changes, the application continually re-prompts the foundation model to receive up-to-date suggestions. The suggestions returned by the foundation model are generated with respect to the current state of the content canvas and are readily available should the user wish to view them.

In an implementation, when a user opens a canvas or board for a project in an application, the application proactively and continually prompts a foundation model to suggest content for the project. When the user requests suggestions for content for the project, the application surfaces the suggestions generated by the foundation model based on the current state of the board. When the user selects a suggestion, the application prompts the foundation model to generate the requested content according to the suggestion. Thus, the application obtains suggestions and content to enhance the board based on the suggestions, without the user having to submit his/her own natural language request. This enables the application to be immediately responsive to the user request. Moreover, as the state of the board changes (e.g., as content is added to the board), the application re-prompts the foundation model to receive up-to-date suggestions and enhancements for the canvas content.

To prompt the foundation model to generate suggestions for content, content enhancements, or other material, the application captures contextual information relating to the application canvas or board, such as a board state, a meeting state, a user state, and user feedback or activity. The contextual information can influence how the model generates its output. For example, given a board with many content items, the output generated by the model may be more narrowly tailored to the board content or project. In contrast, for a board at the early stages of inception, the output may be broader in scope and have more general applicability. As content items are added to the board or other interactions occur with respect to the board, these provide additional context to the model for tailoring its output.

The board state includes information and/or metadata for notes (e.g., virtual sticky notes), posts, or other content items on the board, such as the text content of the content items, the authors of the various content items, a record of modifications to the content items, and reactions of other users (e.g., emojis) to the content items. The board state can include communications between users sharing the board, such as in a chat pane of the board. The board state can also include information regarding relationships between content items, such as when one note is placed near or on top of another note, when a group of notes are positioned in a cluster, when a note is moved to another position on the board, and so on.

In some scenarios, multiple users may be viewing or interacting with respective instances of a canvas or board in the context of an online meeting, such as for project planning. Contextual information in the prompt to the foundation model can also include information relating to a meeting state for the online meeting. The meeting state includes information or metadata such as the communications exchanged between the users in a meeting chat pane of the board (e.g., comments, responses, and reactions), a text transcript of the meeting, information about the meeting attendees (e.g., the number of attendees, organizational titles of the attendees, the participation level of each of the attendees), and information from or relating to a calendar invite for the meeting, such as the invite text and any notes or attachments. The meeting state can also include the time elapsed or time remaining in the meeting when a prompt is submitted to the foundation model.

Contextual information in the prompt to the foundation model can also include user state information. The user state relates to a user's interaction with a board, such as the user's viewport (i.e., the area of the board visible to the user), the user's activities with respect to content items on the board, and the user's activities with respect to the board (e.g., changing the board title, reactions to another user's notes, application tools used by the user). The user's activities can also include interactions with content items generated by the foundation model. For example, when the application displays suggestions for content enhancements generated by the foundation model, the user may perform actions with respect to the suggestions, such as selecting an action to be performed by the model, refreshing the list of suggestions, or deleting undesirable suggestions.

In various implementations, the foundation model is prompted to generate suggestions at various times while the board is open on a user's computing device. For example, the application may prompt the foundation model to generate suggestions and content enhancements when the board is opened in the application. The application may prompt the foundation model to generate suggestions and enhancements each time a change to the board state, meeting state, and/or user state is detected, such as when a content item is added, when a message is entered in the chat pane, or when the user rearranges content items on the board. In some scenarios, where there is a high frequency of activity on the board, the application may prompt the foundation model to generate suggestions at regular intervals (e.g., every five seconds) or when a pause in the activity is detected to minimize excessive processing. In some cases, the suggestions and enhancements may be generated on-demand, such as when the user clicks a button to display the AI-generated suggestions.

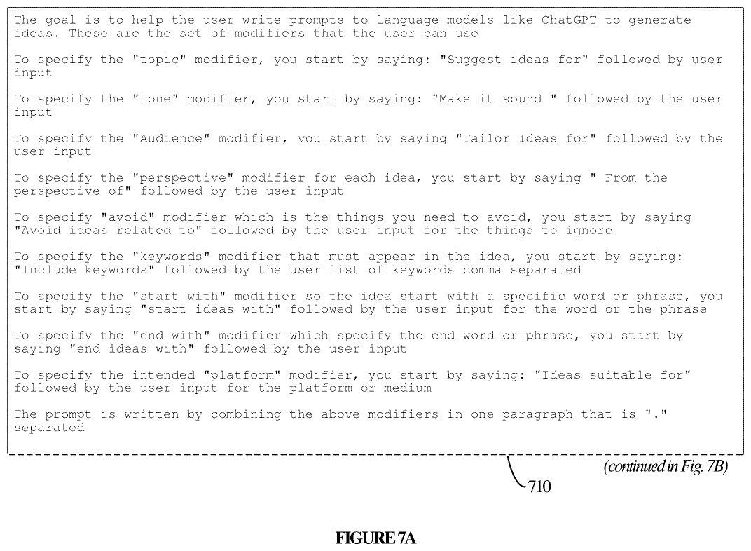

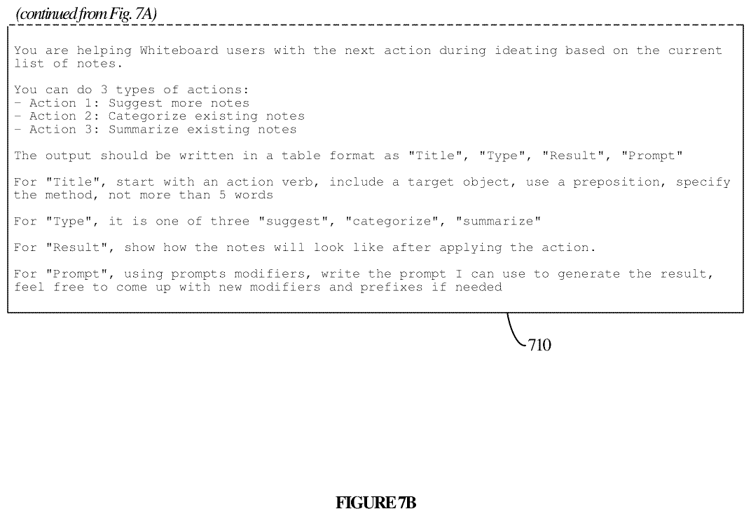

To prompt the foundation model to generate suggestions and content enhancements for a board, the application may configure a prompt based on a prompt template including information relating to the board contextual information. In an implementation, the prompt template tasks the foundation model with suggesting follow-on prompts for content enhancements and titles for the follow-on prompts. The model generates its reply to the prompt taking into account the contextual information of the board to provide material tailored for the board content or project. The follow-on prompts are instructions generated by the model according to a set of rules specified in the prompt; when a follow-on prompt is selected, the corresponding content enhancement can then be generated by the model based on its instructions. The titles of the follow-on prompts are displayed by the application as natural language suggestions, that is, as labels for suggestion components by which the user can request a content enhancement. (An implementation of a prompt template for a prompt to a foundation model for titles, follow-on prompts, and content enhancements is illustrated in FIGS. 7A and 7B, discussed infra.)

In various implementations, the prompt template may also include fields for entering contextual information (e.g., board state information) by which the model will generate its follow-on prompts and corresponding suggestions. The prompt template may also include rules or instructions regarding the manner in which the foundation model is to generate its output. For example, the prompt template may include a rule instructing the foundation model to return its output in a parse-able format, such as in a JavaScript Object Notation (JSON) data object or in semantic tags (e.g., <suggestion>, </suggestion>, <enhancement>, </enhancement>). The rules may also prohibit the model from generating content which may include offensive or insensitive language. The rules may also specify a maximum length or token count of the generated content as well as a temperature indicating the level of creativity or precision with which the model is to generate its output. For example, the foundation model may be instructed to limit titles to no more than five words. In some implementations, the rules may instruct the foundation model to generate its follow-on prompts by generating completions for statements or directives beginning with terms such as “Suggest ideas for,” “Tailor ideas for,”, “Make it sound,” and “From the perspective of.” With a prompt configured, the application may submit the prompt to the foundation model via an application programming interface (API) of the model or of a service hosting the model.

When the foundation model receives a prompt, it generates output in response to the prompt in accordance with its training. The foundation model returns the output to the application, which then parses the output (according to the formatting specified in the prompt) to extract the desired contents. When the model returns a response to a prompt for follow-on prompts and titles, the application extracts the titles and configures them for display in the user interface. For example, titles for the follow-on prompts may be displayed as labels for suggestion components. The application may also store the follow-on prompts in association with the suggestion components; when a user selects a suggestion component, the corresponding follow-on prompt is sent to the model to obtain a content enhancement. When requesting follow-on prompts or a content enhancement based on a selected follow-on prompt, the application may also review the suggestions or content enhancement for appropriate language, use of offensive language, and so on to ensure a satisfactory user experience.

In various implementations, the application hosts a user interface on a user computing device which includes a display of a canvas or board to which various types of content items are to be added, such as content items relating to project planning. Content items may be posted (or deleted) by users to whom the board is shared. The content items include can include virtual sticky notes which can be edited and repositioned on the board, comment cards by which a user can key in a comment, emojis or other symbols of user reactions, freeform drawings, graphical shapes, textboxes, and the like. The board may also include a title and other metadata (e.g., the most recent activity on the board, users to whom the board is shared, etc.). Content canvases to which the various types of content items are added can include word processing documents, presentation slides, note-taking documents, digital whiteboards, and so on. Content canvases may be shared among multiple users who contribute content items for project planning or other collaborative activities. In some scenarios, applications may host online meetings in an application environment in which a content canvas is displayed and with which multiple remote users may interact in real-time.

In the user interface, the application also displays a graphical input device, such as a button, by which a user can request suggestions for enhancements to the board content. In an implementation, when the user selects the button, the application displays a dropdown menu of suggestion components generated by the foundation model based on the contextual information. For example, in the dropdown menu, the user may be presented with selectable buttons or other graphical elements labeled with titles corresponding to follow-on prompts.

When the user selects a suggestion component, the application submits the corresponding follow-on prompt to the foundation model to generate a content enhancement responsive to the follow-on prompt. When the application receives the content enhancement generated by the model, the application displays the enhancement in the user interface. In some implementations, the format for displaying the enhancement is determined based on the type of output. For example, an enhancement which includes multiple items may be displayed as multiple virtual sticky notes on the board, while a summary of the board contents may be presented as a textbox on the board.

In some instances, when the user selects a suggestion component, the content enhancement generated by the model affects the display of existing content items on the board. For example, a suggestion may be to categorize various content items according to some specified criteria. When the user selects the suggestion, the foundation model returns a scheme for organizing the content items, such as arranging the items to be grouped in a particular way, to distinguish the groups by color, and/or by adding a title to the groups. The application implements the scheme by rearranging and modifying the content items on the board.

In some implementations, to interact with the foundation model, the application includes a virtual assistant service which captures contextual information from the board and which configures and submits prompts to the foundation model. The virtual assistant service may receive the output generated by the foundation model and configure the output for display in the user interface.

In various implementations, technology for proactive prompting as disclosed herein may be implemented in project-planning or collaboration applications, but also productivity applications, such as word-processing applications, presentation applications, note-taking applications, or other applications which support environments for content generation and ideation.

Foundation models of the technology disclosed herein include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Types of foundation models may be broadly classified as or include pre-trained models, base models, and knowledge models, depending on the particular characteristics or usage of the model. Foundation models may be multimodal or unimodal depending on the modality of the inputs.

Multimodal models are a class of foundation model which extend their pre-trained knowledge and representation capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are creative, open-ended, and unpredictable.

The technical effects of technology disclosed herein for proactively prompting a foundation model for ideation and content generation include a streamlined user experience which bypasses the need for user input. In automating the prompting process, the user is relieved of not only the task of configuring a natural language prompt but also of engaging in a conversational exchange with the foundation model to obtain useful content. Streamlining the process not only improves the user's productivity, but because the application captures the relevant contextual information automatically, the technology promotes more rapid convergence to optimal content generation, thus reducing the number of interactions which would otherwise be necessary.

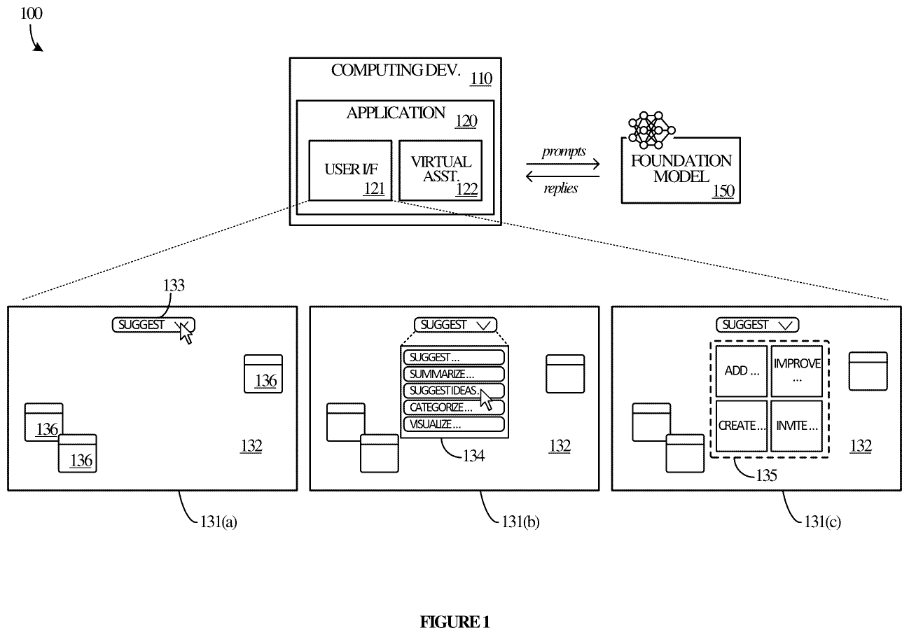

Turning now to the Figures, FIG. 1 illustrates operational environment 100 for proactive, dynamic prompting for content generation via a foundation model integration in an implementation. Operational environment 100 includes computing device 110 which hosts application 120 including user interface 121 and virtual assistant 122. User interface 121 displays user experiences 131(a), 131(b), and 131(c) of application 120. Computing device 110 is in communication with foundation model 150, including sending prompts to foundation model 150 and receiving output generated by foundation model 150 in accordance with its training.

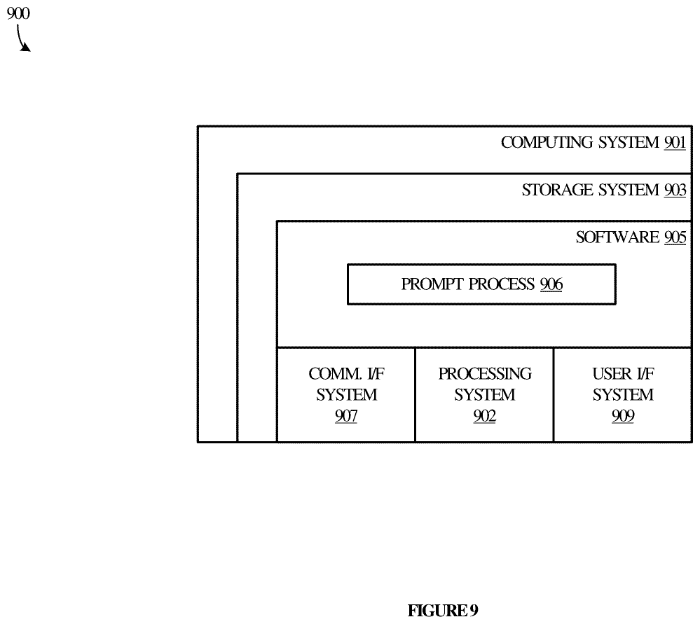

Computing device 110 is representative of a computing device, such as a laptop or desktop computer, or mobile computing device, such as a tablet computer or cellular phone, of which computing system 901 in FIG. 9 is broadly representative. Computing device 110 communicates with application 120 via one or more internets and intranets, the Internet, wired or wireless networks, local area networks (LANs), wide area networks (WANs), and any other type of network or combination thereof. A user interacts with application 120 via user interface 121 displayed on computing device 110.

Computing device 110 executes application 120 locally that provides a local user experience, as illustrated by user experiences 131(a), 131(b), and 131(c), via user interface 121. Application 120 running locally with respect to computing device 110 may be a natively installed and executed application, a browser-based application, a mobile application, a streamed application, or any other type of application capable of interfacing with foundation model 150 and providing a user experience displayed in user interface 121 on computing device 110. Application 120 may execute in a stand-alone manner, within the context of another application, or in some other manner entirely.

User interface 121 displays a project canvas or board hosted by application 120. For example, the canvas may be a project canvas, a text or word processing document, a slide presentation, or the like. In user interface 121, user experiences 131(a), 131(b), and 131(c) are representative of a local user experience hosted by application 120, by virtual assistant 122, or by another service of application 120, in an implementation.

Application 120 is representative of a software application by which a user can create and edit text-based content, such as a word processing application, a collaborative or project application, or other productivity application, and which can generate prompts for submission to foundation models, such as foundation model 150. Application 120 may execute locally on a user computing device, such as computing device 110, or application 120 may execute on one or more servers in communication with computing device 110 over one or more wired or wireless connections, causing user interface 121 to be displayed on computing device 110. In some scenarios, application 120 may execute in a distributed fashion, with a combination of client-side and server-side processes, services, and sub-services. For example, the core logic of application 120 may execute on a remote server system with user interface 121 displayed on a client device. In still other scenarios, computing device 110 is a server computing device, such as an application server, capable of displaying user interface 121, and application 120 executes locally with respect to computing device 110.

Application 120 executing locally with respect to computing device 110 may execute in a stand-alone manner, within the context of another application such as a presentation application or word processing application, or in some other manner entirely. In an implementation, application 120 hosted by a remote application service and running locally with respect to computing device 110 may be a natively installed and executed application, a browser-based application, a mobile application, a streamed application, or any other type of application capable of interfacing with the remote application service and providing local user experiences displayed in user interface 121 on the remote computing device.

Foundation model 150 is representative of a deep learning model, such as BERT, ERNIE, T5, XLNet, or of a generative pretrained transformer (GPT) computing architecture, such as GPT-3®, GPT-3.5, ChatGPT®, or GPT-4. Foundation model 150 is hosted by one or more computing services which provide services by which application service 120 can communicate with foundation model 150, such as an application programming interface (API). In communicating with application service 120, foundation model 150 may send and receive information (e.g., prompts and replies to prompts) in data objects, such as JSON objects. Foundation model 150 may be implemented in the context of one or more server computers co-located or distributed across one or more data centers.

A brief operational scenario of operational environment 100 follows. A user of computing device 110 interacts with application 120 hosting board 132 displayed in user interface 121. User experiences 131(a), 131(b), and 131(c) include Suggest button 133 and content items 136. As the user interacts with application 120 via user interface 121, virtual assistant 122 prompts foundation model 150 for suggestions for ideas or enhancements to the content of board 132. When the user clicks or selects Suggest button 133, virtual assistant 122 causes menu 134 to be displayed which includes suggestion components labeled with titles that were generated by foundation model 150 based on contextual information of board 132, such as the text content of content items 136. In menu 134, the user can select a suggestion which will cause virtual assistant 122 to prompt foundation model 150 to create content in accordance with the suggestion. The user can also delete suggestion components which the user deems unsuitable.

In user experience 131(b), the user selects a suggestion component from menu 134, “Suggest ideas . . . .” Upon making the selection, virtual assistant 122 sends the corresponding follow-on prompt to foundation model 150 to receive content generated in accordance with the suggestion. When foundation model 150 returns a reply to the prompt, virtual assistant parses the output to extract the generated content and configures a display of the content on board 132, as illustrated in user experience 131(c).

In user experience 131(c), the generated content enhancement is pasted onto board 132 in a format appropriate for the type of content generated. For ideation, for example, the output may be displayed as a set of virtual sticky notes 135. For other types of output, other formats may be selected, such as textboxes, selectable text elements (e.g., hyperlinks), graphical boxes for AI-generated images, and so on. In some scenarios, the output changes the style and arrangement of existing content items on board 132.

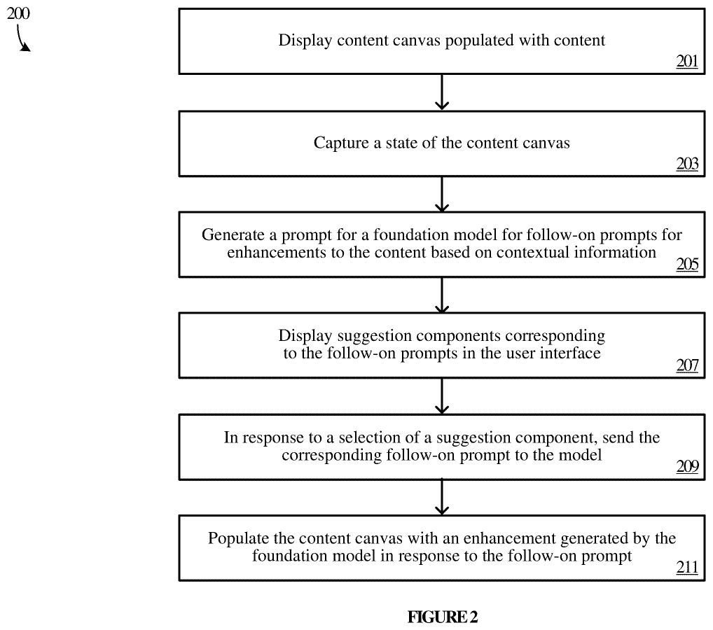

FIG. 2 illustrates a process for proactive prompting for content generation via a foundation model integration in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

The computing device displays a content canvas which is populated with content (step 201). In an implementation, an application executing on the computing device displays a user interface including a content canvas, such as a project board. The content canvas includes content items such as virtual sticky notes, comment cards, etc., relating to a project. The application may be a word processing application, presentation application, note-taking application, whiteboard application, or the like, and the canvas may be shared with other users who can view or edit content on the canvas, such as for project planning or other collaborative activity. The technology is also applicable to ideation and content generation for a variety of media types, such as image, video, or audio content. The foundation model may be prompted to generate multiple suggestions for content enhancements based on contextual information drawn from the application environment, and then to generate content according to a user-selected suggestion.

In an implementation, the computing device also displays a virtual assistant button in the application environment for invoking a virtual assistant of the application. The computing device displays a graphical input device, such as a button, by which the user can cause the application to execute the virtual assistant which interacts with the user interface and the foundation model in various steps of process 200 to obtain content generated by a foundation model and to display the content in the application environment in the user interface.

The computing device captures a state of the content canvas (step 203). In an implementation, the computing device captures the canvas or board state (i.e., contextual information from the canvas or board) for a prompt for the foundation model. The board state includes information from and metadata relating to the board. Information from the board includes contents of a content items on the board, authors of content items, a revision history of the board and its content items including date and time of creation, user reactions to content items, the placement of content items on the board, the repositioning of content items on the board, and so on. Board state information can also include the format of the board, such as the style of the background, a title of the board, fonts, colors, and so on.

Continuing with process 200, the computing device generates a prompt for a foundation model for follow-on prompts for generating enhancements to the content based on contextual information (step 205). In an implementation, the computing device prompts the foundation model to generate follow-on prompts which include a set of natural language instructions crafted by the model based on the supplied contextual information. For each follow-on prompt, the model is tasked with generating the natural language instructions by selecting modifiers, generating completions for the modifiers, and appending the completions to the modifiers to form the instructions. Each set of instructions created by the foundation model forms a follow-on prompt by which the model can generate enhancements in subsequent request. The model may be tasked with creating multiple instruction sets for multiple follow-on prompts so the user may be presented with a variety of suggestions for content enhancements. By tasking the foundation model to create the enhancements in a two-step process, the model is able to produce enhancements which are carefully tailored with attention to the contextual information and according to instructions which are narrowly focused to generate highly relevant and specific enhancements. In an implementation, the foundation model is also tasked with generating titles for each of the follow-on prompts. The titles are displayed by the computing device as natural language suggestions by which the user can select an enhancement.

In an implementation, the computing device configures the prompt for the content enhancements to include the board state to provide context for the foundation model to tailor its output. In some scenarios, the prompt may also include other contextual information, such as a meeting state and/or a user state. The meeting state relates to information from and metadata relating to an online meeting hosted by the application in which the board is displayed to one or more users or collaborators. The meeting state includes messages or conversational exchanges during the meeting in a chat pane, along with the users posting in the chat pane, a transcript of the meeting that may be generated by a transcription service of the application, the elapsed time and/or time remaining of the meeting, information from a calendar invite for the meeting, attendees and their organizational titles, and so on. The user state includes information that is specific to the user interacting with the computing device, such as the user's activities on the board (posting notes, reacting to posts of other users, etc.) as well as the user's viewport (e.g., the portion of the board the user is viewing in the user interface or the content items which are currently visible in user's viewport).

In some instances, the user's actions with respect to content generated by the foundation model is included in the prompt. For example, when the computing device has displayed suggestions or enhancements generated by the foundation model, if the user has selected or deleted a suggestion, those activities may be included in the prompt to provide additional context for the foundation model to tailor its output.

In tasking the model to generate suggestions, follow-on prompts, or content enhancements, the computing device may provide other instructions or rules to the foundation model which constrain its generative activity. For example, the computing device may instruct the foundation model that its follow-on prompts will be submitted to the foundation model for content generation. The computing device may also instruct the model to generate multiple follow-on prompts (e.g., at least three and/or no more than five) and to limit the token size or word length of the natural language suggestions (titles) or enhancements. For example, the prompt may task the model with generating the content enhancements of suitable length for a particular type of content item, such as generating content of length or format appropriate for virtual sticky notes on a content board. Similarly, the natural language suggestions (titles) may be limited to a particular word or character length. Other instructions may include generating its output in a parse-able format (e.g., a JSON object with the suggestions enclosed within semantic tags). The prompt may also include rules relating to the language the suggestions are to be created in (e.g., English) and guardrails for avoiding potentially offensive or insensitive terms or phrases.

The computing device, in various implementations, configures a data object (e.g., a JSON object) including the prompt and submits the data object to the foundation model via an API hosted by the model. Upon receiving the data object, the foundation model generates its reply in response to the prompt and returns its reply to the computing device via the API. When prompted to generate suggestions for enhancements to the content, the foundation model returns a response (e.g., data object) including at least the follow-on prompts.

The computing device displays suggestion components corresponding to the follow-on prompts in the user interface (step 207). In an implementation, the computing device displays natural language suggestions for each of the follow-on prompts generated by the foundation model. The suggestions are short phrases by which the user can select an enhancement for addition to the content canvas. For example, the suggestions may be hyperlinks or labels of selection components which cause the computing device to send the corresponding follow-on prompt to the foundation model. In various implementations, the foundation model is tasked with generating the natural language suggestions for the enhancements for display in the user interface. For example, the model may be tasked with generating titles for the follow-on prompts, and the computing device receives and displays the titles as natural language suggestions in the user interface. The computing device may parse the data object returned by the foundation model to extract the titles of the follow-on prompts, then display graphical elements (e.g., a dropdown menu, buttons or other selectable elements) which are labeled with the titles. The user can then select a suggestion component to receive a content enhancement generated according to the follow-on prompt of the selected suggestion.

In some scenarios, the user may delete a suggestion component surfaced in the user interface, and an indication of this action may be included as part of the user feedback context provided to the model. In some implementations, if the user is dissatisfied with the suggestions, the user may select a button in the user interface which causes the computing device to prompt the foundation model for another set of suggestions. In prompting the foundation model to generate another set, the computing device may include the already-generated but rejected suggestions to discourage or prevent the foundation model repeating any of the suggestions and to aid the model in generating more useful suggestions and follow-on prompts.

When the computing device receives user input selecting a suggestion component, the computing device sends the corresponding follow-on prompt to the foundation model (step 209). In an implementation, when the computing device receives the follow-on prompts from the foundation model, the computing device stores the follow-on prompts in association with the suggestion components. When a user selects a suggestion component, the computing device sends the corresponding follow-on prompt via the API to the foundation model. The foundation model returns a reply including the content enhancement generated according to the follow-on prompt.

In an implementation, the follow-on prompt tasks the foundation model with generating a content enhancement according to the set of instructions included in the follow-on prompt. The follow-on prompt may also include contextual information such as the board state, meeting state, user state, and user feedback. The follow-on prompt may also include rules and instructions to limit the token size or word length of the enhancement.

When the computing device receives the reply from the foundation model, the computing device populates the whiteboard with the enhancement (step 211). In an implementation, the computing device creates a content item including the enhancement which was generated by the model according to the follow-on prompt and displays the content item(s) on the project canvas. The format of the content item(s) may be determined by the computing device based on the type of content generated by the foundation model or on the type of suggestion that was selected. For example, where the foundation model returns an enhancement including a list of multiple items, the computing device may display the items individually on virtual sticky notes or as a set in a textbox. If the foundation model returns a summary of the contents of the canvas, the computing device may display the summary in a specially formatted and labeled textbox on the project canvas. In some implementations, the computing device may surface a preview window in which the user can review and edit the generated enhancement before causing the computing device to add the content to the document.

In some implementations, in response to populating the canvas, the computing device may capture an updated state of the canvas (as populating the canvas with the enhancement effects a change to the state of the canvas). The computing device generates a prompt to obtain an updated set of suggestions. When the user selects the Suggest button, the computing device displays the updated set of suggestions which is responsive to the most current or recent state of the canvas.

Returning to FIG. 1, operational environment 100 includes a brief example of process 200 as employed by elements of operational environment 100 in an implementation. Computing device 110 runs application 120 including causing a local user experience to be displayed via user interface 121. Application 120 may execute locally with respect to computing device 110, or computing device 110 may host application 120 which executes on one or more server computing devices remote from and in communication with computing device 110, or application 120 may execute in distributed, client-server fashion.

In operational environment 100, application 120 displays board 132 including content items 136 in user interface 121. A user interacts with application 120 to generate content for board 132. Application 120 includes services for generating content, such as virtual assistant 122 by which to generate content, ideas, or suggestions for the user via a foundation model integration. Application 120 displays Suggest button 133 which invokes virtual assistant 122 to display suggestions generated by foundation model 150 based on the board state of board 132.

Virtual assistant 122 prompts foundation model 150 to generate follow-on prompts which will task foundation model 150 with generating content for enhancing or improving the content of board 132. In various implementations, prompting is triggered by a change in the state of board 132 and by the opening of board 132. In some implementations, prompting is on-demand (e.g., based on user input) or occurs at regular intervals while board 132 is open in user interface 121. To provide context for foundation model 150 in generating the follow-on prompts, visual assistant 122 captures information relating to the current state of the board, such as the contents of content items 136, metadata of board 132, and other information, such as a meeting state (when board 132 is open in the context of an online meeting hosted by application 120), a user state, and user feedback (if any).

When prompted, foundation model 150 returns follow-on prompts for enhancing the content of board 132. The follow-on prompts are tailored by the model according to contextual information provided in the prompt. Upon receiving the follow-on prompts from foundation model 150, virtual assistant 122 generates a display of suggestion components which, when the user selects Suggest button 133, is surfaced in user interface 121.

In user experience 131(a), the user selects Suggest button 133. In user experience 131(b), virtual assistant 122 displays menu 134 including suggestion components corresponding to follow-on prompts for enhancements generated by foundation model 150 based on the current or most recently capture state of board 132. In an implementation, the suggestion components are labeled with titles of the follow-on prompts that were generated by foundation model 150 along with generating the follow-on prompts. Virtual assistant 122 receives a selection by the user of a suggestion component from among the suggestions in menu 134. When the selection is received, virtual assistant 122 prompts foundation model 150 to generate an enhancement according to the selected suggestion. In user experience 131(c), virtual assistant 122 causes the enhancement to be displayed as virtual sticky notes 135 on board 132.

The user may continue to interact with board 132, such as creating new content items, rearranging or editing existing content items, and deleting content items. As the user interacts with board 132, virtual assistant 122 proactively prompts foundation model 150 to generate follow-on prompts for generating enhancements based on a state of the board at the time of prompting in anticipation of the user requesting suggestions during the interaction.

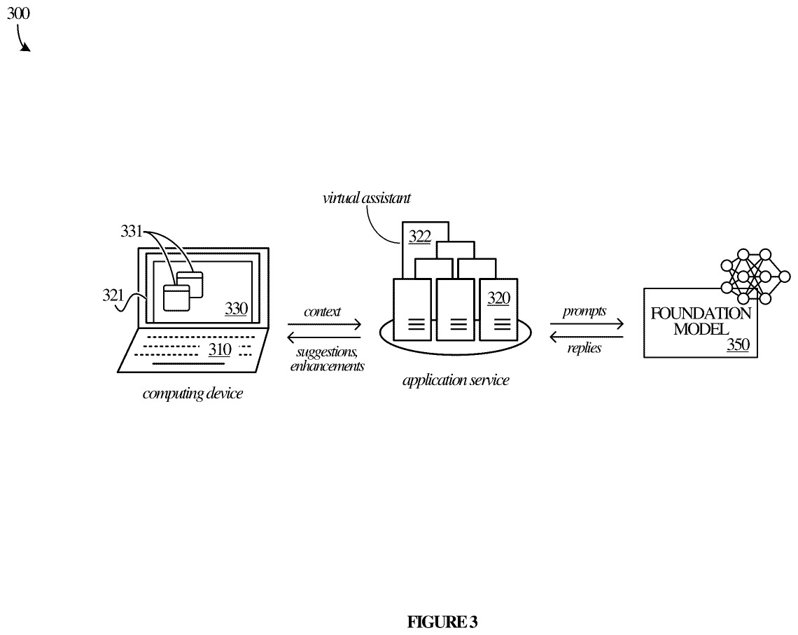

FIG. 3 illustrates operational environment 300 for proactive prompting in an application environment via a foundation model integration in an implementation. Operational environment 300 includes computing device 310, application service 320, and foundation model 350. Application service 320 hosts an application to endpoints such as computing device 310. Computing device 310 executes an application locally that provides a local user experience 321 and that interfaces with application service 320. The application running locally with respect to computing device 310 may be a natively installed and executed application, a browser-based application, a mobile application, a streamed application, or any other type of application capable of interfacing with application service 320 and providing user experience 321 displayed on computing device 310. Applications hosted by application service 320 to endpoints may execute in a stand-alone manner, within the context of another application or in some other manner entirely.

Computing device 310 is representative of a computing device, such as a laptop or desktop computer, or mobile computing device, such as a tablet computer or cellular phone, of which computing system 901 in FIG. 9 is broadly representative. Computing device 310 communicates with application service 320 via one or more internets and intranets, the Internet, wired or wireless networks, local area networks (LANs), wide area networks (WANs), and any other type of network or combination thereof. A user interacts with an application of application service 320 via a user interface of the application displayed on computing device 310. User experience 321 displayed on computing device 310 are representative of user experiences of an application environment of application service 320 in an implementation.

Application service 320 is representative of one or more computing services capable of hosting an application and interfacing with computing device 310 and foundation model 350. Application service 320 employs one or more server computers co-located or distributed across one or more data centers connected to computing device 310. Examples of such servers include web servers, application servers, virtual or physical (bare metal) servers, or any combination or variation thereof, of which computing system 901 in FIG. 9 is broadly representative. Application service 320 may communicate with computing device 310 via one or more internets, intranets, the Internet, wired and wireless networks, local area networks (LANs), wide area networks (WANs), and any other type of network or combination thereof. Examples of services or sub-services of application service 320 include—but are not limited to—content assistants (e.g., virtual assistant 322), prompt engines, and other application services.

User experience 321 displayed on computing device 310 displays board 330 with content items 331. Board 330 also includes a graphical user input device by which a user can request suggestions for enhancing the content of board 330. Application service 320 hosts a user interface which displays user experience 321. Virtual assistant 322 can receive user input and display output generated by foundation model 350 in user experience 321.

Foundation model 350 is representative of a deep learning model, such as BERT, ERNIE, T5, XLNet, or of a generative pretrained transformer (GPT) computing architecture, such as GPT-3®, GPT-3.5, ChatGPT®, or GPT-4. Foundation model 350 is hosted by one or more computing services which provide services by which application service 320 can communicate with foundation model 350, such as an application programming interface (API). Foundation model 350 may be implemented in the context of one or more server computers co-located or distributed across one or more data centers.

In operation, computing device 310 communicates with application service 320 to transmit user input received in user experience 321 and to receive output from application service 320, including suggestions and enhancements generated by foundation model 350. Application service 320 communicates with foundation model 350 to transmit requests for foundation model 350 to generate content and to receive replies generated in response to those requests.

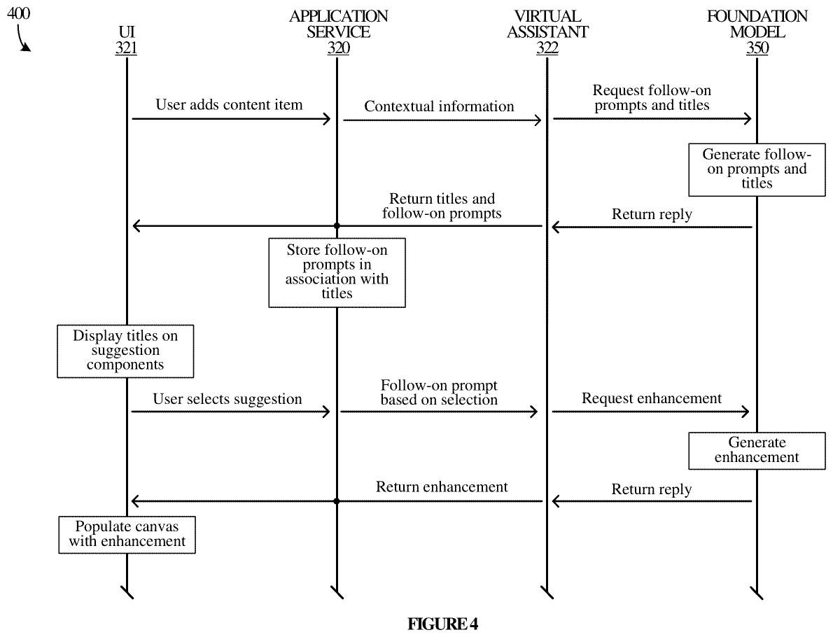

FIG. 4 illustrates operational scenario 400 for proactive prompting via a foundation model integration in an implementation, referring to elements of FIG. 3. In operational scenario 400, a user is interacting with board 330 in user interface 321 hosted by application service 320, such as adding or editing content items to board 330 relating to a project. As the user interacts with the board 330, virtual assistant 322 detects the changes to the board 330 and, in response, captures contextual information relating to the state of board 330 and a user state from application service 320. In some scenarios, where board 330 is being edited in the context of an online meeting, the prompt may include a meeting state.

Operational scenario 400 continues with virtual assistant 322 submitting a prompt to foundation model 350 which requests follow-on prompts for generating content enhancements for board 330. In requesting the follow-on prompts, in an implementation, the foundation model is tasked with generating a title for each of the follow-on prompts. Foundation model 350 generates the requested material and returns a reply to virtual assistant 322. Virtual assistant 322 parses the reply to extract the follow-on prompts and titles. Application service 320 prepares the titles for display in user interface 321 as labels of suggestion components by which the user can select the corresponding enhancement. In an implementation, application service 320 stores the follow-on prompts for retrieval in response to a selection of a corresponding suggestion component. When the titles are displayed in user interface 321 (as selectable suggestions for content enhancements), application service 320 receives user input indicating a selection of a suggestion for an enhancement. Virtual assistant 322 sends the corresponding follow-on prompt to foundation model 350 requesting an enhancement corresponding to the selected suggestion. In some implementations, application service 320 includes contextual information relating to the state of board 330 and a user state from application service 320, and, if applicable, a meeting state with the follow-on prompt. Virtual assistant 322 submits the follow-on prompt along with any contextual information to foundation model 350 which generates and returns the requested output. Virtual assistant 322 extracts the enhancement from the output, which application service 320 processes for display in user interface 321.

The workflow illustrated in operational scenario 400 may continue with virtual assistant 322 obtaining updated follow-on prompts and titles as the state of board 330 changes, receiving user selections of suggestions (titles), and displaying enhancements based on the selected suggestions from foundation model 350. In some scenarios, the user may request a new set of suggestions should none of the presented suggestions prove suitable for the user's needs. The user's actions with respect to the suggestions (e.g., selecting a suggestion, deleting a suggestion, requesting a new set of suggestions) may be sent to foundation model 350 in subsequent prompts as contextual information.

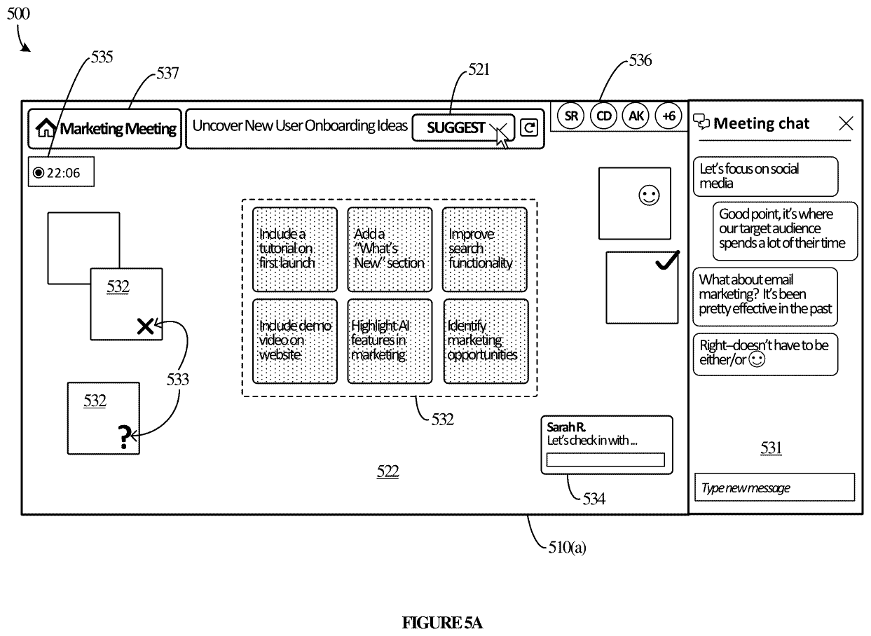

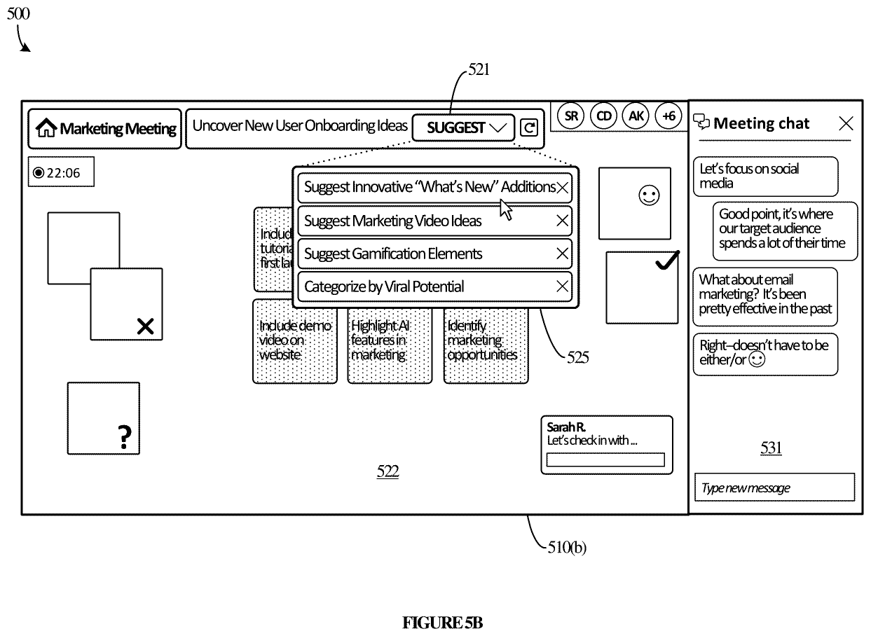

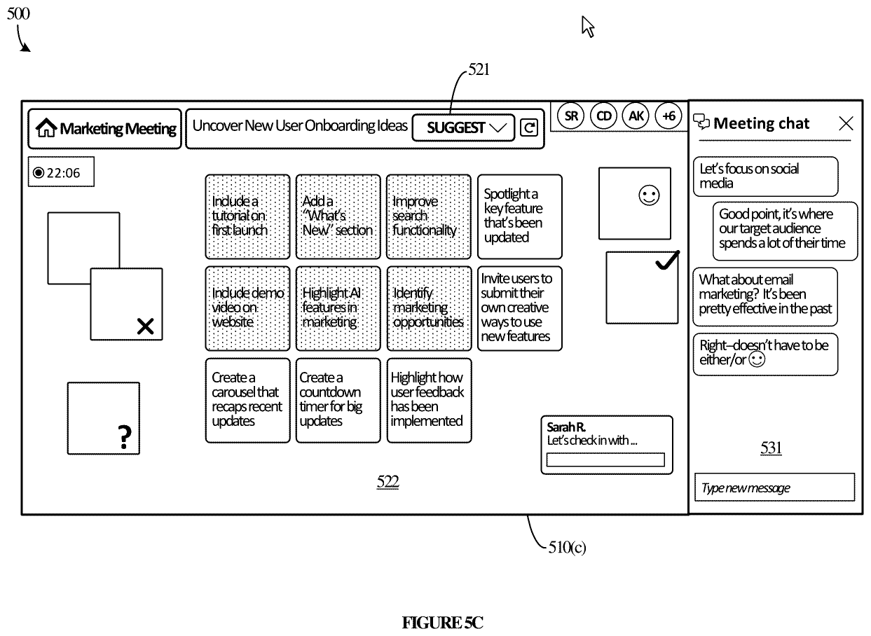

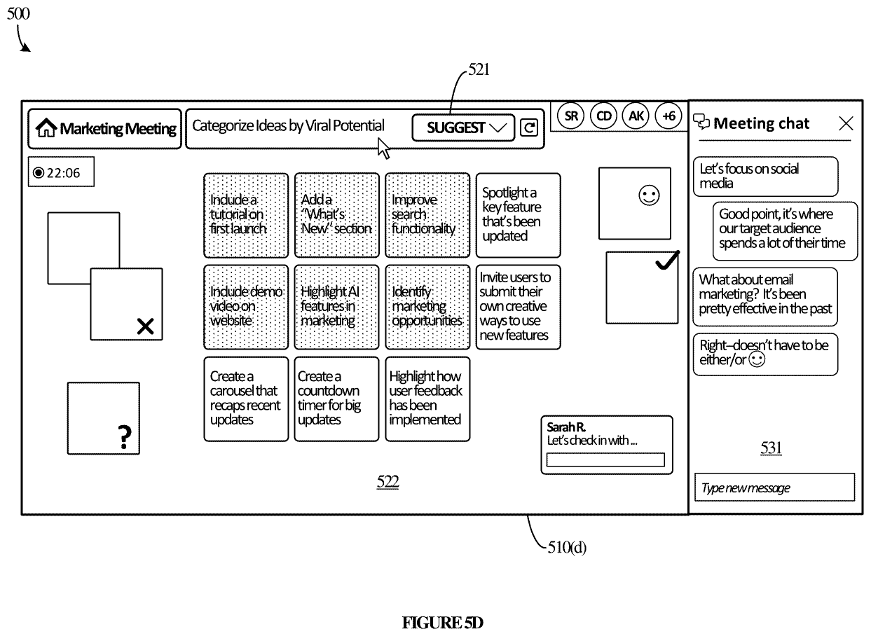

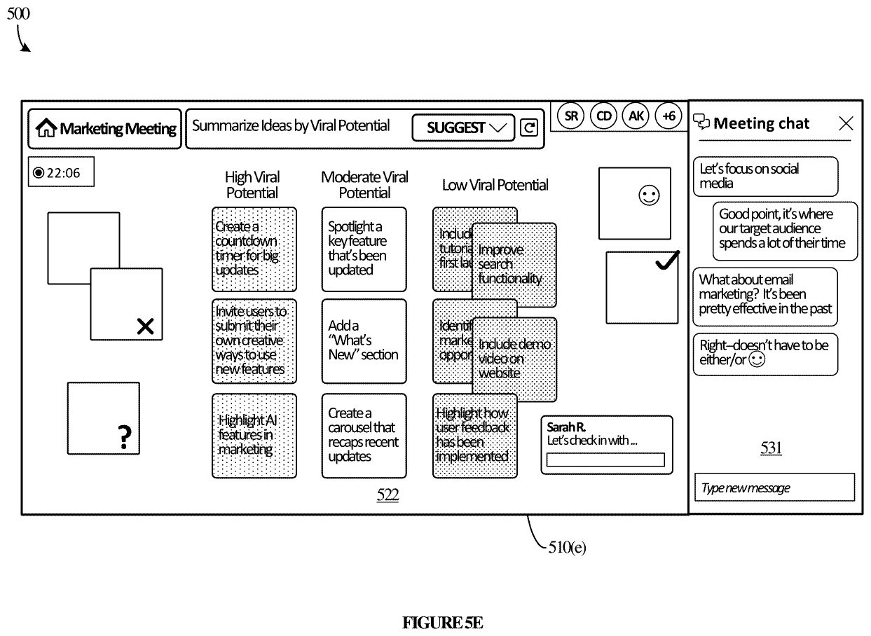

FIGS. 5A-5E illustrate user experiences of operational scenario 500 for a proactive prompting for content generation via a foundation model integration of an application, such as a project planning application, in an implementation. In user experience 510(a) of FIG. 5A, the application generates a prompt for submission to a foundation model which tasks the foundation model with suggesting follow-on prompts which task the model with generating suggestions or ideas for enhancing the content of board 522.

In user experience 510(a) of FIG. 5A, a user clicks the Suggest button 521 to display titles of the follow-on prompts in the form of natural language suggestions for enhancing the content of a project displayed on board 522. To obtain the list of titles and corresponding follow-on prompts, the application generates a prompt which includes rules for generating the follow-on prompts based on the content items and other contextual information of board 522. The rules may task the foundation model with selecting an action category among a set of action categories for each follow-on prompt that it generates (e.g., Suggest, Categorize, Summarize, and Visualize) and indicating the action category for each follow-on prompt. To generate the follow-on prompts, the rules task the foundation model with selecting a modifier phrase from a set of given modifier phrases and generating a completion to append to the modifier phrase to form an instruction. One or more instructions created by the foundation model form a follow-on prompt.

The foundation model is also prompted to generate titles for each follow-on prompt which will be displayed to the user. In various implementations, the follow-on prompts are not displayed to the user, so the user's selection is based on the titles. The foundation model may be tasked with generating multiple different follow-on prompts, (e.g., at least three but no more than five) and to limit the size (e.g., character or word length) of the titles for display.

In the various prompts sent to the foundation model during the course of operational scenario 500, the application includes contextual information relating to the board state, the meeting state, and the user state. In user experience 510(a), contextual information can include information relating to content items 532 provided by users and messages and reactions (e.g., emojis) submitted by users in chat pane 531, along with metadata relating to the chat pane 531 (dates, times, authors, etc.). Contextual information can also include information and metadata relating to content items 532 and user reactions 533, comment cards 534, meeting time (elapsed or remaining) as illustrated in box 535, meeting attendees as illustrated in box 536, and board title 537.

In user experience 510(b) of FIG. 5B, the titles of the follow-on prompts generated by the foundation model based on the current state of board 522 are displayed in menu 525, including a “teaser” title next to Suggest button 521. The titles are natural language suggestions by which the user can select to receive a content enhancement for board 522. As illustrated in FIG. 5B, the user clicks Suggest button 521 to reveal the other titles generated by the foundation model in menu 525. A Refresh or Regenerate button may also be displayed by which the user can request a new set of titles (i.e., natural language suggestions). The user selects a follow-on prompt corresponding to the title “Suggest Innovative “What's New” Additions” from among the displayed titles.

Continuing with operational scenario 500, the application inserts, in user experience 510(c) of FIG. 5C, new ideas generated by the foundation model in accordance with the selected follow-on prompt. The newly generated content is formatted and displayed as virtual sticky notes and pasted in an organized fashion onto board 522. The newly generated content may be formatted in a way to distinguish them from content items 532 or to indicate an order in which the content items were created or added to board 522. Adding new content causes a change in the state of the board, and, in response, the application prompts for and receives titles for new follow-on prompts for enhancing the now-updated content of board 522.

In user experience 510(d) of FIG. 5D, the user again selects Suggest button 521 to obtain more follow-on prompts for enhancements to board 522, now based on its updated state. As illustrated in menu 526, the user selects a title to categorize the ideas on the board according to viral potential. When the follow-on prompt corresponding to the selected title is submitted to the foundation model, the model returns a classification of the ideas on board 522 according to viral potential. In user experience 510(e) of FIG. 5E, the application implements the classification by reorganizing the virtual sticky notes of the ideas and reformatting the content items (e.g., changing the note color) to more clearly indicate the classifications.

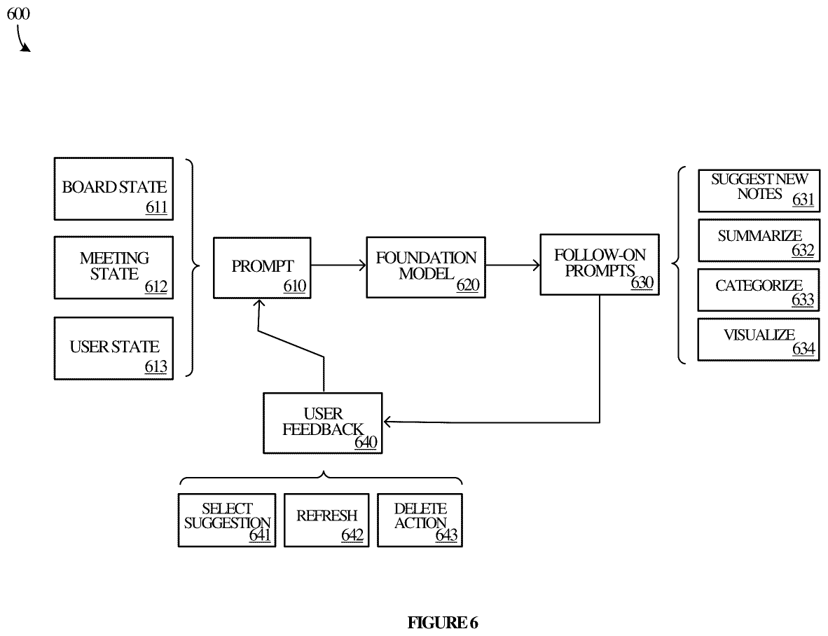

FIG. 6 illustrates workflow 600 for proactive prompting via a foundation model integration to receive suggestions in an implementation. In an implementation, an application service hosts an application on a user computing device. The application displays a user interface including a project canvas or board. The board displays content items relating to planning a project. The user interacts with the project board by adding, modifying, or deleting content items on the board and requesting suggestions for enhancing the content of the board.

In workflow 600, an application service or subservice, such as a virtual assistant, content assistant, or prompt engine, submits prompt 610 to foundation model 620 to obtain suggestions for enhancing the contents of a project canvas or board. Prompt 610 may be submitted by the application service in response to detecting a change to the state of the board, such as a change to the content of the board. In prompt 610, the application includes contextual information including board state 611, meeting state 612, and user state 613.

Board state 611 can include information and/or metadata for notes (e.g., virtual sticky notes), posts, or other content items on the board, such as the text content of the content items, the authors of the various content items, a revision history of the content items, and reactions of other users (e.g., emojis) to the content items. The board state can include communications between users sharing the board, such as in a chat pane of the board. The board state can also include information regarding relationships between content items, such as when one note is placed near or on top of another note, when a group of notes are positioned in a cluster, when a note is moved to another position on the board, and so on. For example, the position of a note may be defined according to the location coordinates of the center point of the note; a cluster may be defined for a group of notes when the distances between the center points of the notes is less than a threshold amount. The board state may also include center-point coordinates of content items to indicate relative positioning of the content items on the board and to indicate how content items have been repositioned.

Meeting state 612 can include information or metadata such as the communications exchanged between the users in a meeting chat pane of the board (e.g., comments, responses, and reactions), a text transcript of the meeting, information about the meeting attendees (e.g., the number of attendees, organizational titles of the attendees, the participation level of each of the attendees), and information from or relating to a calendar invite for the meeting, such as the invite text and any notes or attachments. Meeting state 612 can also include the time elapsed or time remaining in the meeting when a prompt is submitted to foundation model 620.

User state 613 can include information that is specific to the user interacting with the computing device, such as the user's activities on the board (posting notes, reacting to posts of other users, changing the board title, etc.) as well as the user's viewport (e.g., the portion of the board the user is viewing in the user interface). The user's activities can also include interactions with content items generated by the foundation model, such as editing or deleting items that are based on output generated by the foundation model.

When foundation model 620 receives prompt 610, foundation model 620 generates output including follow-on prompts 630. To create follow-on prompts 630, the foundation model selects an action category for each of the follow-on prompts, such as “Suggest new notes” (631), “Summarize” (632), “Categorize” (633), and “Visualize” (634). The action categories guide foundation model 620 in generating the follow-on prompts. Follow-on prompts 630 are sets of instructions formed by foundation model 620 according to a set of rules specified in prompts 630, an implementation of which is illustrated in FIGS. 7A and 7B. According to the rules, the instructions sets which form follow-on prompts 630 are based on modifiers to which foundation model 620 adds completions according to the contextual information in prompt 610. In forming the instruction sets for each of follow-on prompts 630, foundation model 620 may also be instructed that it may create custom modifiers or custom instructions.

Prompt 610 may also task foundation model 620 with generating titles for each of follow-on prompts 630. The titles may be presented in the user interface as suggestions. The suggestions may be presented in the user interface in the form of graphical input devices (e.g., graphical buttons) labeled with the titles. When the user selects a suggestion, the application populates the canvas with output generated based on the corresponding follow-on prompt.

Prompt 610 may also include user feedback 640 based on actions of the user for additional contextual information. User feedback includes the user actions such as selecting a suggestion (641), refreshing the list of suggestions (642), and deleting a suggestion (643).

FIGS. 7A and 7B illustrate prompt template 710 for configuring a prompt for a foundation model in an implementation. Prompt template 710 includes rules or instructions by which to guide the activity of the foundation model in generating suggestions for follow-on prompts and corresponding titles for a canvas or board. As illustrated in FIG. 7A, the foundation model is instructed to generate instructions based on a set of modifiers. The set of modifiers are prefixes to which the foundation model is tasked with generating a completion to form a complete instruction. The foundation model may be tasked with generating a set of one or more instructions to form a suggested follow-on prompt.

In FIG. 7B, prompt template 710 continues with instructions for generating its output. For each suggested follow-on prompts, the instructions task the foundation model with selecting an action category (“Type”), generating a title, generating the output (“Result”), and generating the suggested prompt itself (“Prompt”), including the instructions formed based on the modifier prefixes and completions. The instructions may include a word limit for the titles of the suggested prompts. In generating the results of the suggested prompts, the instructions may specify that the output of the suggested prompt or “Result” should be appropriate for display in a virtual sticky note or other type of content item. In some implementations, the output or Result for a suggested follow-on prompt is not generated with the suggested prompt but is instead generated when the suggested follow-on prompt sent by the application to the model, such as in response to user input selecting a title of the follow-on prompt in the user interface.

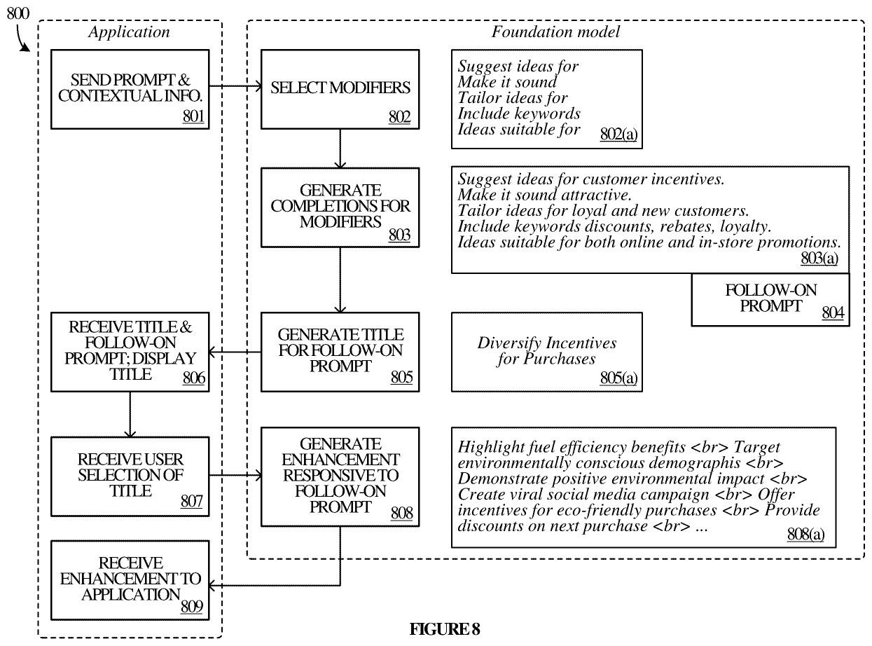

FIG. 8 illustrates an example of generating a content enhancement by process 800 of proactive prompting via a foundation model integration in an implementation. In step 801, an application sends a prompt to a foundation model which requests suggestions for follow-on prompts for content enhancements for a virtual whiteboard of a whiteboard application. (FIG. 8 illustrates the process for generating a single follow-on prompt and enhancement; in various implementations, the foundation model may be tasked with generating multiple follow-on prompts and enhancements for the content canvas in the same manner.) In step 802, in response to receiving the prompt, the foundation model selects modifiers (802(a)) from a set of modifiers suggested in the prompt and, in step 803, generates completions for the selected modifiers to create instructions (803(a)). The set of modifiers and completions form follow-on prompt 804. In step 805, the foundation model generates a title for follow-on prompt 804 (805(a)). In step 806, the model returns follow-on prompt 804 and corresponding title to the application, and the application displays the title in the application environment. In step 807, the application receives user input selecting the title and sends follow-on prompt 804 corresponding to the selection to the foundation model to receive the requested enhancement.

In step 808, the model generates the enhancement based on follow-on prompt 804 (808(a)). In various implementations, follow-on prompt 804 may task the foundation model with returning its output in a format for display, such as XML or HTML In step 809, the model returns the enhancement to the whiteboard application. The application may populate the project canvas or board with multiple content items for each of the ideas generated in the enhancement, such as populating a virtual whiteboard of a whiteboard application with virtual sticky notes.

Turning now to FIG. 9, architecture 900 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements prompt process 906, which is (are) representative of the prompt processes discussed with respect to the preceding Figures, such as process 200 and workflow 600. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including prompt process 906) may be implemented in program instructions and among other functions may, when executed by processing system 902, direct processing system 902 to operate as described with respect to the various operational scenarios, sequences, and processes illustrated herein. For example, software 905 may include program instructions for implementing a prompt process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support proactive prompt processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method of operating an application on a computing device, the method comprising:
displaying, in a user interface of the application, a content canvas populated with content;
capturing a state of the content canvas;
generating a prompt for a foundation model, wherein the prompt tasks the foundation model with generating follow-on prompts for enhancements to the content of the content canvas based on contextual information, wherein the contextual information includes the state of the content canvas;
displaying, in a user interface of the application, suggestion components corresponding to the follow-on prompts; and
in response to a selection of a suggestion component of the suggestion components:
sending, to the foundation model, a follow-on prompt corresponding to the selected suggestion component; and
populating the content canvas with an enhancement generated by the foundation model in response to the follow-on prompt.

2. The method of claim 1, wherein the prompt further tasks the foundation model with generating titles for the follow-on prompts, and wherein displaying the suggestion components corresponding to the follow-on prompts comprises displaying the suggestion components labeled with the titles.

3. The method of claim 2, wherein capturing the state of the content canvas further comprises capturing the state of the content canvas in response to detecting a change to the state of the content canvas.

4. The method of claim 3, further comprising:
in response to a second change in the state of the content canvas:
capturing an updated state of the content canvas; and
generating a third prompt for the foundation model including the updated state of the content canvas, wherein the third prompt tasks the foundation model with generating new suggestions for enhancements to the content based on the updated state of the content canvas.

5. The method of claim 4, wherein the content canvas comprises a virtual whiteboard, wherein the content comprises content items, and wherein content items comprise virtual sticky notes.

6. The method of claim 5, wherein the state of the content canvas comprises one or more of: text from the content items, authors of the content items, reactions to the content items, a placement of the content items relative to other content items on the content canvas, and content canvas metadata.

7. The method of claim 6, wherein the contextual information further comprises a meeting state, wherein the meeting state comprises one or more of: a chat pane message, a meeting transcript, an elapsed time, and a calendar invite.

8. The method of claim 7, wherein the contextual information further comprises a user state, wherein the user state comprises a viewport and user activity with respect to the content canvas.

9. The method of claim 8, wherein the contextual information further comprises user feedback with respect to a suggestion generated by the foundation model.

10. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
display, in a user interface of the application, a content canvas populated with content;
capture a state of the content canvas;
generate a prompt for a foundation model, wherein the prompt tasks the foundation model with generating follow-on prompts for enhancements to the content of the content canvas based on contextual information, wherein the contextual information includes the state of the content canvas;
display, in a user interface of the application, suggestion components corresponding to the follow-on prompts; and
in response to a selection of a suggestion component of the suggestion components:
send, to the foundation model, a follow-on prompt corresponding to the selected suggestion component; and
populate the content canvas with an enhancement generated by the foundation model in response to the follow-on prompt.

11. The computing apparatus of claim 10, wherein the prompt further tasks the foundation model with generating titles for the follow-on prompts, and wherein to display the suggestion components corresponding to the follow-on prompts, the program instructions direct the computing apparatus to display the suggestion components labeled with the titles.

12. The computing apparatus of claim 11, wherein to capture the state of the content canvas, the program instructions direct the computing apparatus to capture the state of the content canvas in response to detecting a change to the state of the content canvas.

13. The computing apparatus of claim 12, wherein the program instructions further direct the computing apparatus to:
in response to a second change in the state of the content canvas,
capture an updated state of the content canvas; and
generate a third prompt for the foundation model including the updated state of the content canvas, wherein the third prompt tasks the foundation model with generating new suggestions for enhancing the content based on the updated state of the content canvas.

14. The computing apparatus of claim 13, wherein the content comprises content items, and wherein the content items comprise virtual sticky notes.

15. The computing apparatus of claim 14, wherein the state of the content canvas comprises one or more of: text from the content items, authors of the content items, reactions to the content items, a placement of the content items relative to other content items on the content canvas, and content canvas metadata.

16. The computing apparatus of claim 15, wherein the contextual information further comprises a meeting state, wherein the meeting state comprises one or more of: a chat pane message, a meeting transcript, an elapsed time, and a calendar invite.

17. The computing apparatus of claim 16, wherein the contextual information further comprises a user state, wherein the user state comprises a viewport and user activity with respect to the content canvas.

18. One or more computer-readable storage media having program instructions stored thereon that, when executed by one or more processors of a computing device, direct the computing device to at least:
display, in a user interface of the application, a content canvas populated with content;
capture a state of the content canvas;
generate a prompt for a foundation model, wherein the prompt tasks the foundation model with generating follow-on prompts for enhancements to the content of the content canvas based on contextual information, wherein the contextual information includes the state of the content canvas;
display, in a user interface of the application, suggestion components corresponding to the follow-on prompts; and
in response to a selection of a suggestion component of the suggestion components:
send, to the foundation model, a follow-on prompt corresponding to the selected suggestion component; and
populate the content canvas with an enhancement generated by the foundation model in response to the follow-on prompt.

19. The one or more computer-readable storage media of claim 18, wherein the prompt further tasks the foundation model with generating titles for the follow-on prompts, and wherein to display the suggestion components corresponding to the follow-on prompts, the program instructions direct the computing device to display the suggestion components labeled with the titles.

20. The one or more computer-readable storage media of claim 19, wherein to capture the state of the content canvas, the program instructions direct the computing device to capture the state of the content canvas in response to detecting a change to the state of the content canvas.
